(19) United States
(12) Patent Application Publication
(10) Pub. No.: US 2020/0136129 A1
(43) Pub. Date: Apr. 30, 2020

(54) CATHODE INK FORMULATIONS AND METHODS FOR A SOLID-STATE LITHIUM-ION BATTERY

(71) Applicant: Government of the United States, as represented by the Secretary of the Air Force, Wright-Patterson AFB, OH (US)

(72) Inventors: Lazarus J. DEINER, Brooklyn, NY (US); Michael A. ROTTMAYER, Dayton, OH (US); Thomas JENKINS, Beavercreek, OH (US); Thomas G. HOWELL, Lebanon, OH (US)

(73) Assignee: Government of the United States, as represented by the Secretary of the Air Force, Wright-Patterson AFB, OH (US)

(21) Appl. No.: 16/669,165

(22) Filed: Oct. 30, 2019

Related U.S. Application Data
(60) Provisional application No. 62/753,872, filed on Oct. 31, 2018.
(60) Provisional application No. 62/753,875, filed on Oct. 31, 2018.

(51) Int. Cl. H01M 4/36; H01M 10/0525; H01M 4/58; H01M 4/525; H01M 4/505; H01M 4/62; H01M 4/04

(52) U.S. Cl. CPC H01M 4/362; H01M 10/0525; H01M 4/5825; H01M 4/525; H01M 2004/028; H01M 4/622; H01M 4/625; H01M 4/0419; H01M 4/505

(57) ABSTRACT

A drop-on-demand printable ink composition for a cathode of a solid-state lithium ion battery. The ink composition includes a cathode material configured to conduct lithium ions, a polymeric binder, and a solvent. The polymeric binder has a number average molecular weight ranging from about 5 kDa to about 5 MDa and the solvent has a boiling point under standard atmospheric conditions ranging from about 50° C. to about 225° C. A ratio of solid material to solvent ranges from about 1:100 to about 40:60 and a viscosity of the ink composition ranges from about 5 mPa·s to about 40 mPa·s.

Pursuant to 37 C.F.R. § 1.78(a)(4), this application claims the benefit of and priority to prior filed co-pending Provisional Application Ser. Nos. 62/753,872 filed Oct. 31, 2018 and 62/753,875 filed Oct. 31, 2018. This application is also related to U.S. application Ser. No. 16/373,285, entitled INK FORMULATIONS AND METHODS FOR AN ELECTROLYTE FOR A SOLID STATE LITHIUM-ION BATTERY, and filed Apr. 2, 2019. The disclosure of each application cited here is expressly incorporated herein by reference in its entirety.

### RIGHTS OF THE GOVERNMENT

The invention described herein may be manufactured and used by or for the Government of the United States for all governmental purposes without the payment of any royalty.

### FIELD OF THE INVENTION

The present invention relates generally to compositions and manufacturing methods for solid-state lithium-ion battery electrodes and, more particularly, to compositions and manufacturing methods for electrodes having high areal capacity and high rate capability.

### BACKGROUND OF THE INVENTION

Solid-state batteries have a wide range of applications including portable power, wearable power, electrical vehicle power, small air vehicle power, and large air vehicle auxiliary power. Unlike conventional batteries, solid-state batteries have no liquid or semi-liquid components and thus have enhanced safety features.

One difficulty in integrating lithium-ion batteries into the devices is controlling dimension of the fabricated components across micro-to-meso length scales. Digital printing methods provide patterning ability across these scales. Various printing modalities have produced thin cathodes with high specific capacity and acceptable rate capability. Inkjet printed LiFePO₄ cathodes (less than 5 μm thick on Al current collectors) showed gravimetric capacities as high as 130 mAhg⁻¹ when discharged at a C/10 rate. A 1.2 μm thick inkjet printed LiCoO₂ cathode displayed a maximum capacity of 120 mAhg⁻¹ when discharged at 180 μAcm⁻², equivalent to 5C.

A simultaneously high specific capacity of 150 mAhg⁻¹ and rate (10C) has also been shown for a thin (18 μm) LiMn₁₋ₓFeₓPO₄ cathode created via 3-D printing. 3-D printing methods of fabricating thick (greater than 100 μm) microstructured cathodes have been explored in order to improve areal capacities beyond what has been possible for the thin printed cathodes.

The first demonstration resulted in a LiFePO₄ half-cell with an area normalized capacity of greater than 1.5 mAhcm⁻² at rates below 5C. Recently, the 3-D printing method was further improved to yield a fully printed LFP/LTO battery with a capacity of 4.45 mAhcm⁻² at a discharge current of 0.14 mAcm⁻². A similar 3-D printing method was applied to microstructuring LiMn₂O₄ cathodes that were hundreds of microns thick. When tested in half cell configuration at C/10, the mass and area normalized capacities were above 100 mAhg⁻¹, and 4 mAhcm⁻², respectively.

Yet, there remains the need for methods of utilizing inkjet and/or aerosol jet printing to achieve the high areal capacities of thick cathodes thus far only demonstrated with direct ink writing methods of 3-D printing. This would be an important achievement because the multiple nozzles of inkjet and wide print heads of aerosol jet may enable faster print speeds than direct ink writing methods of 3-D printing. Inkjet and aerosol jet may thus be well suited to high volume manufacture of large areas of device integrated energy storage.

### SUMMARY OF THE INVENTION

The present invention overcomes the foregoing problems and other shortcomings, drawbacks, and challenges of compositions and methods suitable for aerosol jet printing of lithium ion cathodes. While the invention will be described in connection with certain embodiments, it will be understood that the invention is not limited to these embodiments. To the contrary, this invention includes all alternatives, modifications, and equivalents as may be included within the spirit and scope of the present invention.

According to embodiments of the present invention, a drop-on-demand printable ink composition for a cathode of a solid-state lithium ion battery that includes a cathode material configured to conduct lithium ions, a polymeric binder, and a solvent. The polymeric binder has a number average molecular weight ranging from about 5 kDa to about 5 MDa and the solvent has a boiling point under standard atmospheric conditions ranging from about 50° C. to about 225° C. A ratio of solid material to solvent ranges from about 1:100 to about 40:60 and a viscosity of the ink composition ranges from about 5 mPa·s to about 40 mPa·s.

Other embodiments of the present invention are directed to a method for preparing a printable composition for a solid lithium ion cathode, the method comprising mixing a solvent with a polymeric binder. The solvent having a boiling point under standard atmospheric conditions ranging from about 50° C. to about 225° C., and the polymeric binder having a number average molecular weight ranging from about 5 kDa to about 5 MDa. A cathode material is introduced into the mixture. A ratio of solid material to solvent ranges from about 1:100 to about 40:60, and a viscosity of the ink composition ranges from about 5 mPa·s to about 40 mPa·s.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a side-elevational, schematic view, in cross-section, of an aerosol jet printer suitable for use in methods of the present invention.

FIG. 2 graphically illustrates viscosities of cathode compositions relative to shear rates.

FIGS. 3 and 5 are top view scanning electron microscopy images of a LiFePO₄ cathode prepared through conventional tape casting.

FIGS. 4 and 6 are top view scanning electron microscopy images of a LiFePO₄ cathode prepared in accordance with embodiments of the present invention.

FIGS. 7-9 are cross-sectional, scanning electronic microscopy images of the LiFePO₄ of FIGS. 4 and 6.

FIG. 10 graphically illustrates voltage versus discharge capacity for LiFePO₄ cathodes prepared in accordance with embodiments of the present invention tested at rates of C/15 (line “a”), C/10 (line “b”), C/5 (line “c”), C/2 (line “d”), and 1C (line “e”).

FIG. 11 graphically illustrates cyclic voltammetry for LiFePO₄ cathodes prepared in accordance with embodiments of the present invention cycled in battery half-cell configurations with Li foil anode.

FIG. 12 graphically illustrates peak anodic and cathodic currents for LiFePO₄ cathodes prepared in accordance with embodiments of the present invention as a function of square root of the scan rate.

FIGS. 13A and 13B graphically illustrate electrochemical impedance spectroscopy measurements and demonstrate a decrease in charge transfer resistance of the battery after the first charge cycle.

FIG. 14 graphically illustrates the area and mass normalized capacity for LiFePO₄ cathodes prepared in accordance with embodiments of the present invention as a function of discharge current densities.

FIG. 15 graphically illustrates average discharge capacities recorded for LiFePO₄ cathodes prepared in accordance with embodiments of the present invention.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

As used herein, the terms “standard conditions” and “standard temperature and pressure” (or “STP”) means conditions in which temperature ranges from about 20° C. to about 30° C. and pressure is about 1 atmosphere.

The term “standard atmospheric conditions” means conditions in which temperature ranges from about 20° C. to about 30° C., pressure is about 1 atmosphere, and relative humidity ranges from about 0% to about 80%.

The term “dry room conditions” means conditions in which relative humidity is 1% or less.

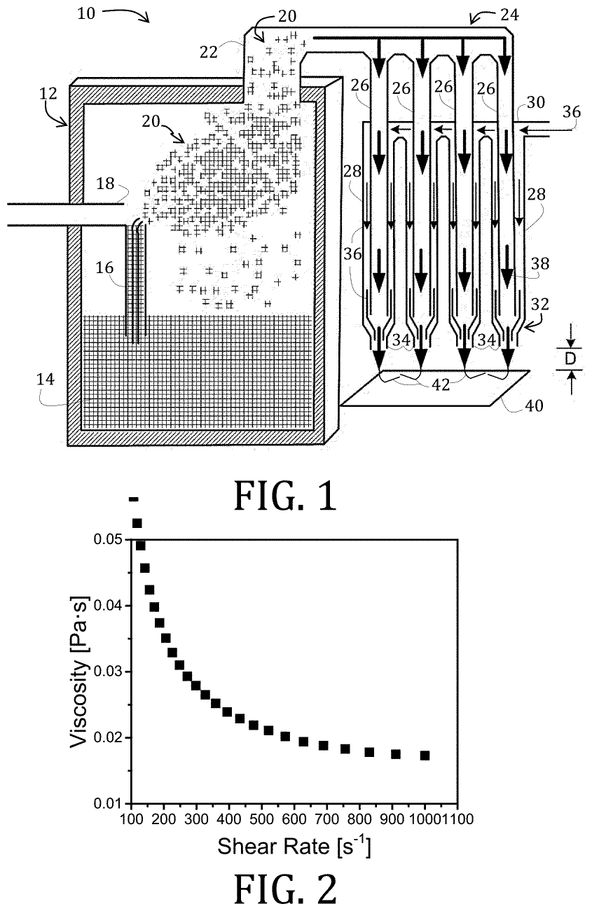

Referring now to the figures, and in particular to FIG. 1, a diagrammatic illustration of a conventional aerosol jet printing system 10 is shown in FIG. 1 and includes an atomizer module 12 for atomizing a cathode composition 14 contained therein. Mist generation of the cathode composition 14 may be achieved by using a mist generator (for example, ultrasonic or pneumatic atomization). As illustrated, the atomizer module 12 includes pneumatic atomization with a capillary 16 positioned proximate to an inert gas outlet 18. In this way, as inert gas, which may be air or nitrogen (for example), exits the outlet 18, cathode composition 14 within the capillary 16 may be atomized to form an aerosol stream 20.

The inert gas may also aid in directing the aerosol stream 20 toward an exit 22 of the atomizer module 12, the exit 22 being operably coupled to a droplet deposition module 24.

Within the deposition module 24, the aerosol stream 20 may be concentrated and directed into a plurality of channels 26. A sheath gas channel 28 is annular and co-axial to each of the plurality of channels 26 and is operably coupled to a sheath gas inlet 30. The deposition module 24 therefore includes a deposition head 32 having a plurality of sheath gas channels 28, each of which is annular and co-axial to a respective channel 26 that ends in a nozzle 34. In use, the sheath gas, indicated by arrow 36, and cathode composition 14, indicated within the channels by arrow 38, flow into respective channels 28, 26, exiting at respective nozzles 34, and are directed toward a substrate 40 that is positioned at a distance, D, away from the nozzles 34. In this way, the sheath gas is configured to focus the streams of cathode composition 42 emitted from the nozzles 34. In some embodiments, the streams 42 may have a diameter that may be as small as a tenth of a diameter of an orifice of the nozzle emitting the cathode composition.

Aerosol jet printing, such as by the exemplary device of FIG. 1, may be conducted at temperatures ranging from less than about 10° C. to about 150° C. or, in some instances, higher. An operating temperature of aerosol jet printing is selected based on the viscosity of the print solution, which according to embodiments herein, is the electrolyte composition 14.

Aerosol jet printing has the advantage of being able to print fine lines, ranging in thickness from about 5 μm to about 15 μm, at higher deposition rates and higher solids loadings as compared to inkjet. The thickness of the deposited material may range from about 0.5 μm to about 300 μm or more; this resolution may be maintained over bumpy or non-uniform substrates because the velocity of the jetting ink is such that stream focus may be maintained for up to 11 mm. The viscosity of the printable cathode composition for use with an aerosol jet printer may range from about 1 mPa·s to about 2000 mPa·s or from about 5 mPa·s to about 1000 mPa·s. By comparison, the viscosity of the printable electrolyte composition using thermal jet printing or piezoelectric jet printing may range from about 1 mPa·s to about 25 mPa·s. Moreover, jettable particle sizes for thermal or piezoelectric inkjet printing are limited as compared to aerosol jet.

Patterning the cathode composition 14 on the substrate 40 may be achieved by attaching the substrate 40 to a computer-controlled platen or by translating the deposition head 32 while the substrate 40 position remains fixed. The aerosol jet printing process may, according to some embodiments, be CAD driven using a standard *.dxf (drawing exchange file).

A distance, D, between the nozzles 34 and the substrate 40 may be relatively large compared to the diameter of the nozzle 34 or the diameter of the streams 42. For example, D may range from about 3 mm to about 11 mm. Accordingly, the aerosol jet printer 10 may be used to deposit material on non-planar substrates, over existing structures, or into channels.

Typically, a lithium ion battery cathode comprises agglomerated primary particles of active intercalation compounds and inactive materials coated onto a current collector. Inactive materials may referred to as polymeric binders and conductive additives. Active materials provide a lithium reservoir for the cathode. Conductive additives increase in the electronic conductivity of the material. Polymeric binders bind the active materials and the conductive additive and provide adhesion to the current collector.

As applied to embodiments of the present invention, the cathode composition includes a cathode material suitable for conducting lithium ions and may include a broad range of lithium-ion battery cathode materials, such as intercalation compounds (for example, LiCoO₂), spinel compounds (for example, LiMn₂O₄), olivine compounds (for example, LiFePO₄), and tavorite compounds (for example, LiFeSO₄F). Exemplary layered compounds suitable for conducting lithium ions may be found in Table 1 of N. NITTA et al., “Li-ion battery materials: present and future,” Mater. Today, Vol. 18 (2015) 252-264, which is incorporated here by reference. For other embodiments, conversion-type cathode materials may be used, such as those found in Table 2 of N. NITTA, supra. The cathode material may be a powder or other dispersible form that may be placed into solution having viscosities suitable for aerosol jet printing.

If desired and according to some embodiments of the present invention, a conductive enhancer may be added to the cathode composition to improve electrical conductivity. Exemplary conductive enhancers may include compounds having a high ratio of electrical conductivity-to-mass (to boost conductivity without significantly diminishing gravimetric capacity) and high dispersability. Conductive enhancers may include carbon black materials (such as carbon super P, carbon super C65, carbon super C45, and acetylene black), graphitic carbon, or other forms of carbon or carbon-based polymeric materials. For some embodiments, particularly those having using a cathode material with sufficiently high electronic conductivity, such as LiFeSO₄F, a conductive enhancer may not be needed or required.

The cathode composition further includes a polymer as an inactive binder that generally does participate in ionic or electronic conduction. Suitable polymers, according to various embodiments of the present invention include polymeric binders. Suitable polymers may have a number average molecular weight ranging from about 5 kDa to about 5 MDa, from about 10 kDa to about 100 kDa, or from about 15 kDa to about 50 kDa. The polymer should also be compatible with the solvent(s) and a lithium salt. Suitable polymers may include, for example, polyalkylene oxides or polyalkylene glycols (including polyethylene oxide, polyethylene glycol, and polypropylene), glycol, polyvinylidene difluoride, polypropylene glycol dimethyl ether, and polymethacrylic acid. The amount of polymer in the cathode composition 14 may range from about 1 wt % to about 50 wt % of the cathode composition 14, such as from about 5 wt % to about 20 wt % or from about 10 wt % to about 15 wt %.

According to an embodiment of the present invention, the cathode composition 14 may be used to form a cathode directly onto a substrate. Solvents that may be suitable for the cathode compositions 14 may be selected from aliphatic hydrocarbons (such as octane), alcohols (such as 2-butanol or diacetone alcohol), t-butyl acetate, acetonitrile, ethylene carbonate, propylene carbonate, diethyl carbonate, dibutyl ketone, N-methyl-2-pyrrolidone, N-butyl pyrrolidone, n-propyl propionate, n-butyl propionate, methyl n-propyl ketone, methyl isobutyl ketone, methyl ethyl ketone, methyl isopropenyl ketone, methyl oleate, or combinations thereof.

Exemplary mixtures of solvents that may have the above identified characteristics are shown in the following table, wherein the volume percent listed in the table are based on 100% of the total solvent composition.

The boiling points of the solvent or mixture of solvents may range from about 50° C. to about 225° C. or from about 80° C. to about 180° C., such as from about 90° C. to about 150° C. The amount of solvent in the cathode composition 14 may range from about 40 wt % to about 99 wt % of the cathode composition 14. The cathode composition may range from about 75 wt % to about 95 wt % solvent, based on a total weight of the cathode composition.

Weight ratios of lithium active material to inactive materials may range from about 97:30 to about 70:30. Weight ratios of polymer to conductive additive may range from about 5:1 to about 5:4. Weight ratios of solids to solvent may range from about 1:100 to about 40:60. According to some particular embodiments, the ratio of solids to solvent may be 1:2.8.

The viscosity of the cathode composition 14 may vary within the printable viscosity ranges for a particular printer, but may generally range from about 5 mPa·s to about 40 mPa·s. Viscosities of exemplary compositions are graphically shown in FIG. 2 as a function of shear rates from about 100 s⁻¹ to about 1100 s⁻¹.

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

### EXAMPLE

A cathode LiFePO₄ ink composition according to an embodiment of the present invention included a 92:3:5 ratio of LiFePO₄ powder-to-carbon SUPER P-to-Kynar 1800. LiFePO₄ power and carbon SUPER P were ground using a mortar and pestle. The mixture was then gradually added to a solvent mixture of 2-butanol and N-methyl 2-pyrrolidone in which Kynar 1800 was previously dissolved. The solution was roller milled for 4-7 days in a glass jar with zirconia milling media. Room temperature viscosity of the milled solution was approximately 20 mPa·s. Irrespective of temperature, the milled solution demonstrated shear thinning behavior as shear rates increased from 100 s⁻¹ to 1100 s⁻¹, as shown in FIG. 2.

Two cathodes were printed using the milled solution on two different days from two different batches of ink prepared of the same composition. All printing was performed in a dry room using an OPTOMEC Aerosol Jet 2000 printer. Eighty print passes of cathode ink were applied to a 75 mm×75 mm area of a carbon coated aluminum substrate whose temperature was maintained at a constant 35° C. The temperature of the ink during printing was 21° C. and deposition rate was 0.1 g/5 min. When printing was complete, the samples were left in the dry room for 4 hrs at 35° C. and then under vacuum overnight at 90° C. The average mass per unit area of the cathode samples were 0.0155 g/cm² and 0.0162 g/cm², respectively.

Morphological characterization of the printed samples was performed using a scanning electron microscope. Electrochemical performance of the cathode samples was tested in coin cell configuration with active material in the cells consisting of the printed cathode ( 9/16 inch), a separator membrane, liquid electrolyte, and a lithium foil anode. Two coin cells from the first printed sample were assembled and three coin cells from the second printed sample were assembled. All coin cells were connected to a battery testing system and subject to constant current charge and discharge cycles with C rates based on measured masses of cathode material and on the approximation that the theoretical capacity of LiFePO₄ is 150 mAh/g. When cut to the 9/16 inch size for testing, the amount of cathode material was 0.03 g.

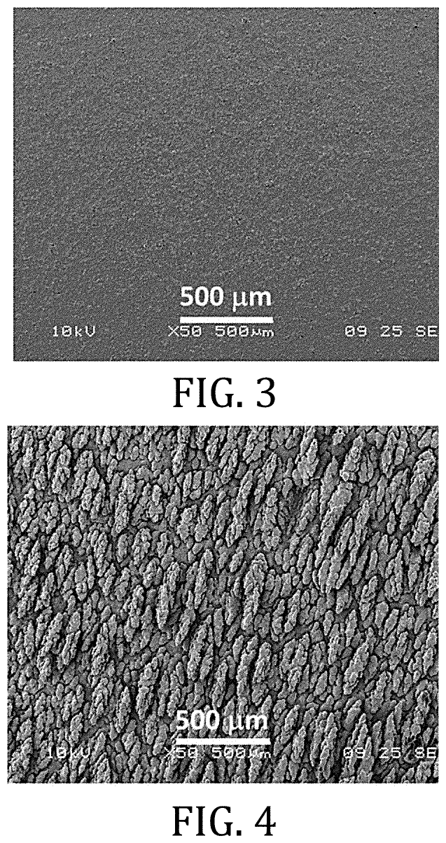

The aerosol jet printed LiFePO₄ cathode possessed a patterned surface not seen in a conventional tape cast LiFePO₄ cathode. For example, FIG. 3 is a scanning electron microscopic (SEM) image of a LiFePO₄ cathode surface prepared in accordance with conventional tape cast methods while FIG. 4 is an SEM image of the LiFePO₄ prepared in accordance with the method described above. The cathode of FIG. 4 demonstrated aligned needles that are several hundred microns long and approximately 50 μm wide. Orientation of the needles is believed to be parallel to the direction of printing and may result from the effect of the sheath gas aligning material as it is deposited on the substrate.

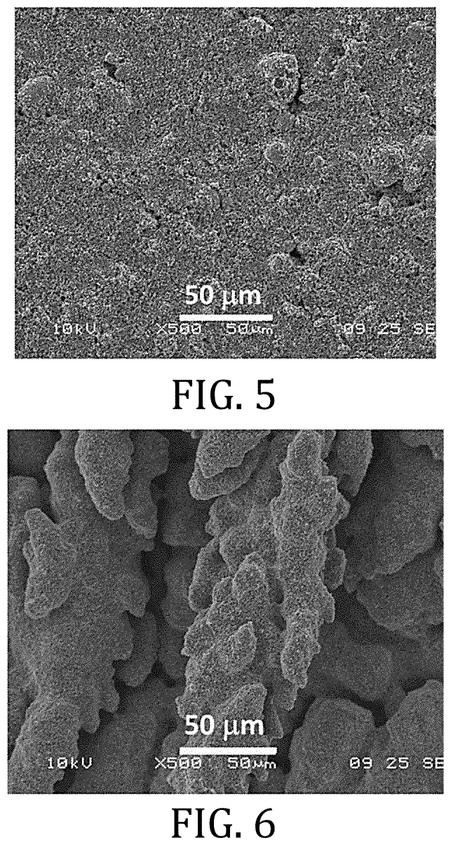

FIGS. 5 and 6 are higher resolution images of FIGS. 3 and 4, respectively. At this higher magnification, the needles of the aerosol jet printed cathode (FIG. 6) are shown with greater detail and comprise overlapping islands of cathode material.

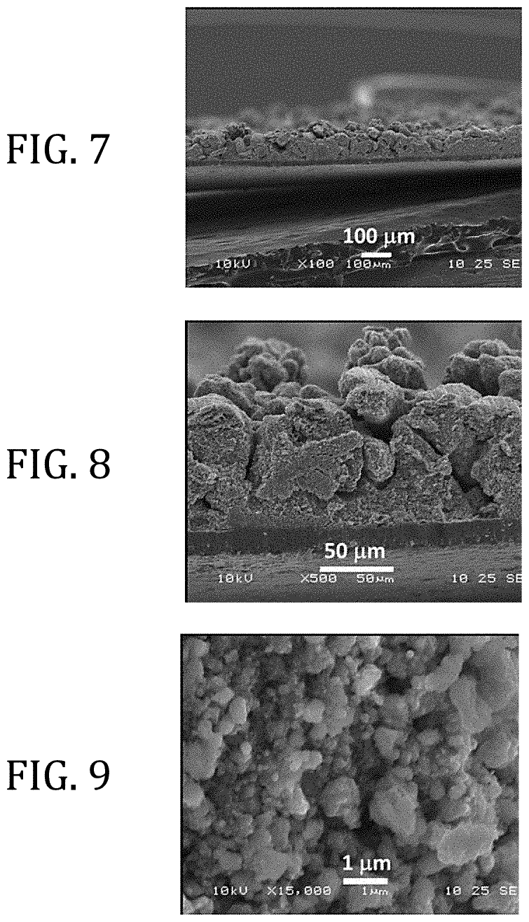

The SEM cross section images of FIGS. 7-9 illustrate that the aligned needles are visible as high points on the cathode. While a thickness of the cathode as measured with a screw micrometer was about 170 μm, SEM image revealed that thickness varied from about 100 μm between adjacent needles to more than 150 μm from the top of the needles to the intersection of the cathode material with the current collector. These dimensions are significantly thicker than the 70 μm thickness of commercially-available LiFePO₄ tape that are manufactured using the tape cast method.

At higher magnification (FIG. 8), the regions between adjacent needles appear as channels whose widths vary from between a few microns and tens of microns. The channels do not appear to have a particular alignment or length. Some channels extend downwardly to the current collector.

At still higher magnification, the channels surround denser regions of cathode material comprising submicron particles and pores. The denser regions appear to be similar to the microstructure of tape cast LiFePO₄. However, a Barrett-Joyner-Halenda (BJH) porosity analysis revealed that the aerosol jet printed cathode has more than three times the pore volume (pores between 1.7 nm and 300 nm) as a conventional tape cast LiFePO₄ cathode. This data is present below in Table 1. Densities of the aerosol jet printed cathodes ranged from 0.9 g/cm³ to 1.0 g/cm³ (as compared to 1.8 g/cm³ for tape cast), which is likely a result of the increased porosity by large channel pores and sub-300 nm pores. This density for the aerosol jet printed cathode was greater than what has been reported for screen printed C-LiFePO₄ cathodes, which was 0.4 g/cm³.

TABLE 1

| | Surface Area | Cumulative | Average Pore |
|---|---|---|---|
| | of Pores | Volume of Pores | Diameter |
| Sample | (m²/g) | (cm³/g) | (nm) |
| Aerosol | 4.3 | 0.082 | 77 |
| Jet Print | | | |
| Tape Cast | 1.6 | 0.025 | 61 |

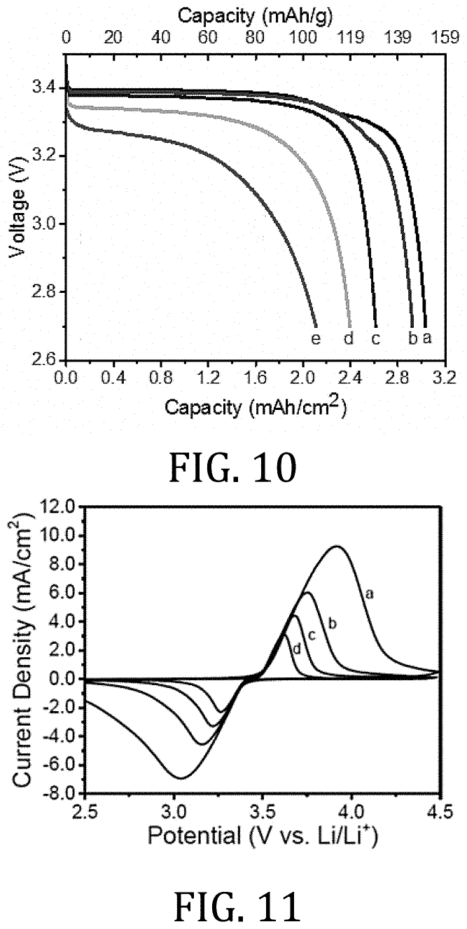

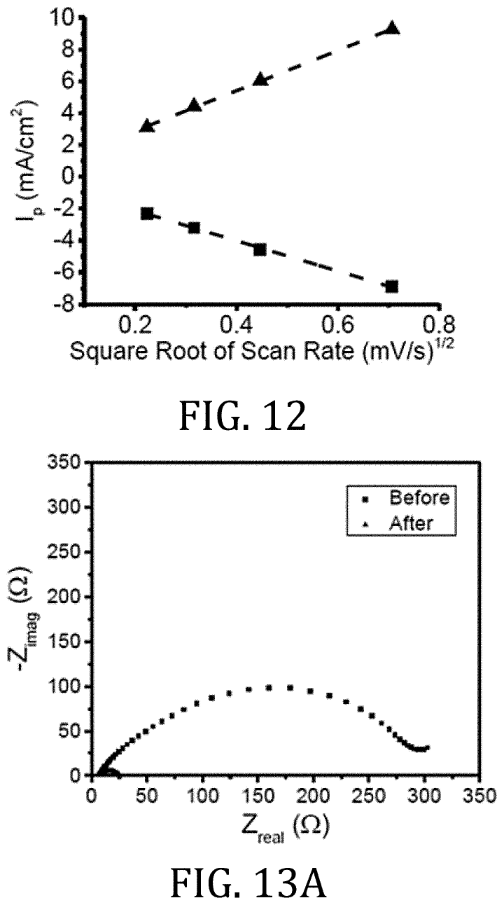

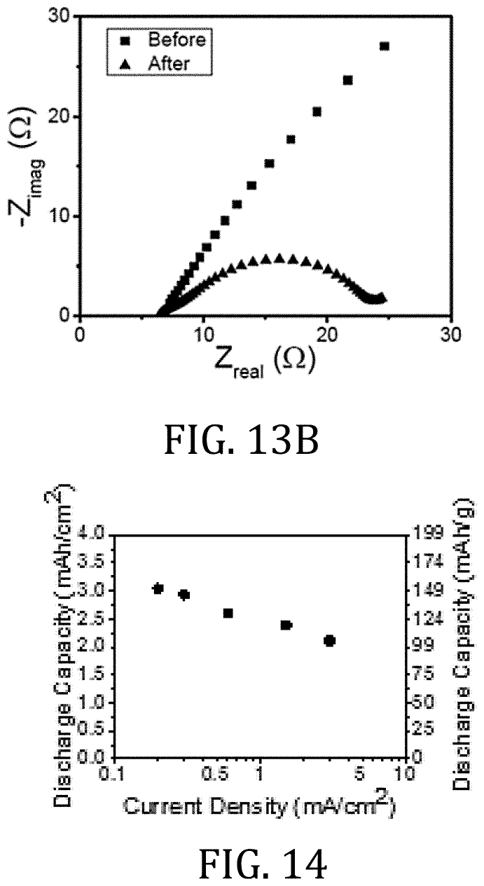

The aerosol jet printed LiFePO₄ cathode displayed a high specific capacity and rate capability when tested in half cell configuration versus a Li-foil anode. The specific discharge capacity was 151 mAhg⁻¹ when discharged at a current of 0.32 mA, which corresponds to a C/15 rate (see line “a” in FIG. 10). When the discharge rate was increased to C/10 (current of 0.48 mA), the specific capacity decreased slightly to 145 mAhg⁻¹ (see line “b” in FIG. 10). Subsequent discharge rate increases to C/5 (current of 0.96 mA), C/2 (current of 2.4 mA), and 1C (current of 4.8 mA), lead to modest decreases in specific discharge capacity from 130 m Ahg⁻¹ to 119 mAhg⁻¹ to 105 mAhg⁻¹, respectively (lines “c,” “d,” and “e” in FIG. 10). Cyclic voltammetry confirmed that the capacity measured corresponded to Li⁺ intercalation/de-intercalation as only one set of anodic/cathodic peaks was detected with a mid-point at 3.44V, the expected open circuit voltage for LiFePO₄ (see FIG. 11). The peak currents were linearly proportional to the square root of the cycling rate in FIG. 12, which suggests reversibility of the intercalation/de-intercalation process. Further, electrochemical impedance spectroscopy before and after the first charge cycle shows the expected behavior for a LiFePO₄ cathode with a decrease in charge transfer resistance from more than 200Ω (x-intercept of curve represented by squares) before the first charge to less than 40Ω (x-intercept of curve represented by triangles) after the first charge (see FIG. 13A). FIG. 13B is an enlarged view of FIG. 13A.

At discharge rates of C/5 or slower, the specific capacity of the 170 μm thick aerosol jet printed cathode was comparable to specific capacities of inkjet printed LiFePO₄ and LiCoO₂ cathodes (thickness of a few microns) thick and screen printed electrodes (thicknesses of 16 μm to 26 μm). At our highest discharge rate, 1C, the specific capacity of the aerosol jet printed cathode ranged from 70% to 90% of the 1C capacity of inkjet printed LiFePO₄ cathodes that are less than 5 μm thick and a screen printed LiFePO₄ cathode that is 26 μm thick.

The C/10 specific capacity of the aerosol jet printed LiFePO₄ cathode was about 5 mAhg⁻¹ greater than tape cast NMC cathodes (both thin, 70 μm, and thick, 320 μm). At C/2 discharge rates, the specific capacity of the 170 μm thick aerosol jet printed electrode was about 5 μm Ahg⁻¹ lower than the 70 μm NMC cathode and about 40 mAhg⁻¹ higher than the 320 μm NMC cathode. These results were unexpected as the theoretical capacity of NMC was as much as 50 mAhg⁻¹ greater than LiFePO₄.

In comparison to a LiMnO₄ cathode comprising a 3-D printed planar base layer with a microstructured 3-D printed layer thereon, the C/10 specific discharge capacity of the 170 μm aerosol jet printed cathode (145 mAhg⁻¹) was greater than the C/10 discharge capacity of the 190 μm, 3-D printed base layer (about 110 mAhg⁻¹) and the cathode (greater than 250 μm thick) with both base layer and microstructured layer (117 mAhg^{-l}). The C/10 specific capacity of the 170 μm aerosol jet printed cathode was similar to 1 mm thick, binder free LiFePO₄ pellets, but the C/2 specific capacity was approximately six times higher. In comparison to porosity optimized 260 μm LiCoO₂ pellets, the C/10 specific capacity is about 10 mAhg⁻¹ higher and the 1C capacity is about 40 mAhg⁻¹ higher.

In addition to displaying high specific capacity, the aerosol jet printed LiFePO₄ cathode maintained a high area normalized capacity across a broad range of discharge rates (FIG. 14). At a discharge current density of 0.2 mAcm⁻², the area normalized discharge capacity was 2.5 mAhcm⁻². The area normalized discharge capacity shows a modest linear decrease with the log of discharge current density such that the area normalized discharge capacity is 1.7 mAhcm⁻² at a high discharge current density of 2.4 mAhcm⁻². For the low discharge current density of 0.2 mAhcm⁻², the area normalized capacity of the aerosol jet printed cathode was significantly lower than that of the best 3-D printed examples. However, as discharge current density increases beyond 1 mAhcm⁻², the aerosol jet printed cathode became more competitive with the 3-D printed cathode. It is hypothesized that the relatively high area normalized capacities of the aerosol jet printed cathode at high discharge rates may be related to its intermediate thickness and unique pore structure. The large channels created by the aligned needle structure may provide less tortuous paths for Li-ion transport through the cathode. The critical role of low tortuosity pore structures, particularly those providing ion transport channels normal to the plane of the cathode, has been investigated in detail for LiCoO₂. The same structural principles are expected to apply to LiFePO₄ cathodes.

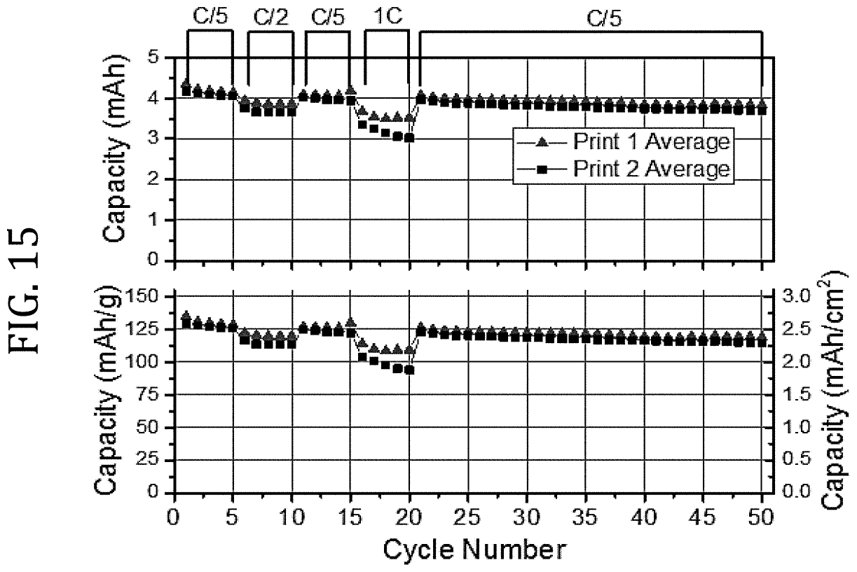

The discharge capacity of the aerosol jet printed LiFePO₄ cathode is stable during a 50 cycle charge/discharge test at rates varying from C/5 to C/2 to 1C (FIG. 15). Based on a total of five half-cell samples made from LiFePO₄ cathode material printed on two different days, an average of 89% of the C/5 capacity was retained after 50 cycles. During five C/2 discharges, the cathodes retained an average of 98% of initial capacity. Similarly, during five 1C discharges, the cathodes retained an average of 93% of initial capacity. As seen in FIG. 15, the stability and discharge capacities of the batteries made from the printed sample B were slightly higher than the stability and discharge capacities of batteries made from printed sample A. These differences may have arisen from small differences in batches of ink or printing conditions. Alternatively, these differences may have arisen because, for a given nominal C-rate, the discharge currents used to test batteries from printed sample B were 5% lower than the discharge currents used to test batteries from printed sample A. As shown in Table 2, the discharge currents used to test the two different sets of batteries were based on the measured mass of deposited material in each cathode. The measured mass of printed sample B was 5% lower than the measured mass of printed sample A.

TABLE 2

| | 1^{st} printed sample | | 2^{nd} printed sample | |
|---|---|---|---|---|
| Nominal | Discharge | Area normalized | Discharge | Area normalized |
| discharge | current | discharge current | current | discharge current |
| rate | [mA] | [mA/cm²] | [mA] | [mA/cm²] |
| C/5 | 0.92 | 0.57 | 0.97 | 0.60 |
| C/2 | 2.30 | 1.43 | 2.42 | 1.51 |
| 1 C | 4.60 | 2.87 | 4.83 | 3.02 |

Taken together, the above results suggest that aerosol jet printing is a route to a high capacity, rate capable, stable LiFePO₄ cathode. It is hypothesized that the unique channel structures, created through aerosol jet printing, contribute to the high capacity of the thick LiFePO₄ by providing less torturous paths for ionic transport.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A drop-on-demand printable ink composition for a cathode of a solid-state lithium ion battery, the ink composition comprising:
a cathode material configured to conduct lithium ions;
a polymeric binder having a number average molecular weight ranging from about 5 kDa to about 5 MDa; and
a solvent having a boiling point under standard atmospheric conditions ranging from about 50° C. to about 225° C.,
wherein a ratio of solid material to solvent ranges from about 1:100 to about 40:60 and a viscosity of the ink composition ranges from about 5 mPa·s to about 40 mPa·s.

2. The ink composition of claim 1, further comprising:
a conductive enhancer.

3. The ink composition of claim 2, wherein the conductive enhancer is carbon black material, graphitic carbon, a carbon-based polymeric material, or combinations thereof.

4. The ink composition of claim 2, wherein a ratio of polymeric binder to conductive enhancer ranges from about 5:1 to about 5:4.

5. The ink composition of claim 1, wherein the number average molecular weight of the polymeric binder ranges from about 10 kDa to about 100 kDa.

6. The ink composition of claim 5, wherein the number average molecular weight of the polymeric binder ranges from about 15 kDa to about 50 kDa.

7. The ink composition of claim 1, wherein the polymeric binder is a polyalkylene oxide, a polyalkylene glycol, a glycol, a polyvinylidene difluoride, a polypropylene glycol dimethyl ether, or a polymethacrylic acid.

8. The ink composition of claim 7, where the polymeric binder is a polyalkylene glycol selected from a polyethylene oxide, a polyethylene glycol, a polypropylene.

9. The ink composition of claim 1, wherein the cathode material is an intercalation compound, a spinel compound, an olivine compound, a tavorite compound, or a conversion-type cathode material.

10. The ink composition of claim 1, wherein the cathode material is LiCoO₂, LiMn₂O₄, LiFePO₄, or LiFeSO₄F.

11. The ink composition of claim 1, wherein the solvent is an aliphatic hydrocarbon, an alcohol, t-butyl acetate, acetonitrile, ethylene carbonate, propylene carbonate, diethyl carbonate, dibutyl ketone, N-methyl-2-pyrrolidone, N-butyl pyrrolidone, n-propyl propionate, n-butyl propionate, methyl n-propyl ketone, methyl isobutyl ketone, methyl ethyl ketone, methyl isopropenyl ketone, methyl oleate, or combinations thereof.

12. The ink composition of claim 1, wherein the solvent is octane, 2-butanol, diacetone alcohol, or combinations thereof.

13. A lithium ion cathode comprising:
the printed and dried ink composition of claim 1.

14. A method of preparing a solid state lithium ion cathode, the method comprising:
using a drop-on-demand printer, printing the ink composition of claim 1 onto a substrate; and
drying the printed composition.

15. The method of claim 14, wherein the drop-on-demand printer selected from the group consisting of an aerosol jet printer, a thermal jet printer, or a piezoelectric jet printer.

16. A method for preparing a printable composition for a solid lithium ion cathode, the method comprising:
mixing a solvent with a polymeric binder, the solvent having a boiling point under standard atmospheric conditions ranging from about 50° C. to about 225° C. and the polymeric binder having a number average molecular weight ranging from about 5 kDa to about 5 MDa; and
introducing a cathode material to the mixture,
a ratio of solid material to solvent ranges from about 1:100 to about 40:60 and a viscosity of the ink composition ranges from about 5 mPa·s to about 40 mPa·s.

17. The method of claim 16, further comprising:
introducing a conductive enhancer with the cathode material, wherein the conductive enhancer is carbon black material, graphitic carbon, a carbon-based polymeric material, or combinations thereof.

18. The method of claim 16, wherein the polymeric binder is a polyalkylene oxide, a polyalkylene glycol, a glycol, a polyvinylidene difluoride, a polypropylene glycol dimethyl ether, or a polymethacrylic acid.

19. The method of claim 16, wherein the cathode material is an intercalation compound, a spinel compound, an olivine compound, a tavorite compound, or a conversion-type cathode material.

20. The method of claim 16, wherein the solvent is an aliphatic hydrocarbon, an alcohol, t-butyl acetate, acetonitrile, ethylene carbonate, propylene carbonate, diethyl carbonate, dibutyl ketone, N-methyl-2-pyrrolidone, N-butyl pyrrolidone, n-propyl propionate, n-butyl propionate, methyl n-propyl ketone, methyl isobutyl ketone, methyl ethyl ketone, methyl isopropenyl ketone, methyl oleate, or combinations thereof.
